(19) United States
(12) Patent Application Publication
(10) Pub. No.: US 2025/0265905 A1
(43) Pub. Date: Aug. 21, 2025

(54) FEATURES FILTER IN A GAME CHOOSER

(71) Applicant: IGT, Las Vegas, NV (US)

(72) Inventors: Sylvie Roussel, Moncton (CA); Richard Savoie, Moncton (CA)

(21) Appl. No.: 18/443,003

(22) Filed: Feb. 15, 2024

(51) Int. Cl. G07F 17/32

(52) U.S. Cl. CPC G07F 17/3267; G07F 17/3248

(57) ABSTRACT

Embodiments are directed to presenting a filtered list of electronic games available on a multigame system by presenting a game selection user interface providing for selection of an electronic game of a plurality of electronic games available on the gaming system and receiving, through the game selection user interface, selection of a feature of a plurality of features of the electronic games available on the gaming system. A list of the electronic games available on the gaming system can be filtered based on the selected feature and the filtered list of the plurality of electronic games available on the gaming system can be presented through the game selection user interface. A selection of an electronic game from the filtered list of the electronic games available on the gaming system can be received through the game selection user interface and execution of the selected electronic game can be initiated.

### BACKGROUND

The present disclosure is generally directed to gaming systems and more particularly to facilitating selection of an electronic game in a multigame gaming system.

A gaming system, such as an Electronic Gaming Machine (EGM) Video Lottery Terminal (VLT), or other system can provide any number of different electronic games. Gaming systems which provide more than one electronic game are referred to as multigame systems. In multigame systems, a player can select one of the available games to play through an interface often referred to as a “chooser.” However, the player may have difficulty identifying a desired game through such an interface. Hence, there is a need in the art for improved systems and methods for facilitating selection of an electronic game in a multigame gaming system.

### BRIEF SUMMARY

Embodiments of the present disclosure are directed to presenting a filtered list of electronic games available on a multigame system. According to one embodiment, a method for selecting electronic games available in a multigame system can comprise presenting a game selection user interface providing for selection of an electronic game of a plurality of electronic games available on the gaming system and receiving, through the game selection user interface, selection of one or more features of a plurality of features of the plurality of electronic games available on the gaming system. A list of the plurality of electronic games available on the gaming system can be filtered based on the selected feature(s) of the plurality of features and the filtered list of the plurality of electronic games available on the gaming system can be presented through the game selection user interface. A selection of an electronic game from the filtered list of the plurality of electronic games available on the gaming system can be received through the game selection user interface. Execution of the selected electronic game can be initiated.

In some cases, the received selection of the feature of the plurality of features can be saved in a profile associated with a player of the selected electronic game. During execution of the selected electronic game, an indication of a suggested electronic game can be provided based on the profile associated with the player of the selected electronic game. A request to switch to the suggested electronic game can be received during execution of the selected electronic game. In response, execution of the selected electronic game can be stopped and execution of the suggested electronic game can be initiated.

Additionally, or alternatively, upon detection of an event in the selected electronic game, a list of a plurality of electronic games can be provided based on the selected feature of the plurality of features. For example, the event in the selected electronic game comprises a cash out from the selected electronic game. In such cases, providing the list of the plurality of electronic games can comprise printing the list of the plurality of electronic games on a cash out ticket. Additionally, or alternatively, providing the list of the plurality of electronic games can comprise providing a pop-up window in a display of the gaming system.

According to another embodiment, a gaming system can comprise a display device, a processor coupled with the display device, and a memory coupled with and readable by the processor. The memory can store therein a set of instructions which, when executed by the processor, causes the processor to present, through the display device, a game selection user interface providing for selection of an electronic game of a plurality of electronic games available on the gaming system and receive, through the game selection user interface, selection of a feature of a plurality of features of the plurality of electronic games available on the gaming system. For example, the selected feature can comprise a free game bonus feature, a wild feature, a multiplier feature, a pick-a-prize bonus feature, a progressive prize feature, etc. The instructions can further cause the processor to filter a list of the plurality of electronic games available on the gaming system based on the selected feature of the plurality of features, present, through the game selection user interface, the filtered list of the plurality of electronic games available on the gaming system, receive, through the game selection user interface, a selection of an electronic game from the filtered list of the plurality of electronic games available on the gaming system, and initiate execution of the selected electronic game.

According to yet another embodiment, an Electronic Gaming Machine (EGM) can comprise a display device, a processor coupled with the display device, and a memory coupled with and readable by the processor. The memory can store therein a set of instructions which, when executed by the processor, causes the processor to present, through the display device, a game selection user interface providing for selection of an electronic game of a plurality of electronic games available on the gaming system, receive, through the game selection user interface, selection of a feature of a plurality of features of the plurality of electronic games available on the gaming system, filter a list of the plurality of electronic games available on the gaming system based on the selected feature of the plurality of features, present, through the game selection user interface, the filtered list of the plurality of electronic games available on the gaming system, receive, through the game selection user interface, a selection of an electronic game from the filtered list of the plurality of electronic games available on the gaming system, and initiate execution of the selected electronic game.

In some cases, the instructions can further cause the processor to save the received selection of the feature of the plurality of features in a profile associated with a player of the selected electronic game. During execution of the selected electronic game, the instructions further cause the processor to provide an indication of a suggested electronic game based on the profile associated with the player of the selected electronic game. The instructions can further cause the processor to receive, during execution of the selected electronic game, a request to switch to the suggested electronic game, stop execution of the selected electronic game, and initiate execution of the suggested electronic game.

Additionally, or alternatively, the instructions further cause the processor to, upon detection of an event in the selected electronic game, provide a list of a plurality of electronic games based on the selected feature of the plurality of features. For example, the event in the selected electronic game can comprise a cash out from the selected electronic game.

Additional features and advantages are described herein and will be apparent from the following Description and the figures.

### BRIEF DESCRIPTION OF THE SEVERAL VIEWS OF THE DRAWINGS

FIG. 1 is a block diagram illustrating an exemplary environment in which embodiments of the present disclosure may be implemented.

FIG. 2 is a block diagram illustrating additional details of components of an exemplary gaming system according to one embodiment of the present disclosure.

FIG. 3 is a flowchart illustrating an exemplary process for presenting available games in a multigame system according to one embodiment of the present disclosure.

FIG. 4 is a flowchart illustrating an exemplary process for presenting available games in a multigame system according to another embodiment of the present disclosure.

FIG. 5 is a flowchart illustrating an exemplary process for presenting available games in a multigame system according to yet another embodiment of the present disclosure.

### DETAILED DESCRIPTION

Embodiments of the present disclosure are directed to presenting a filtered list of electronic games available on a multigame system. Generally speaking, rather than presenting a list of games, e.g., by game name, through a chooser interface of the gaming system, the chooser interface can provide a list of game features. The player can then select one or more desired game features. Based on these selections, the gaming system can present a filtered list of games which include those, selected feature(s). The feature(s) a player selected can also be used, either during execution of a selected game or at the conclusion of the selected game, to present suggestions of other games also having those features.

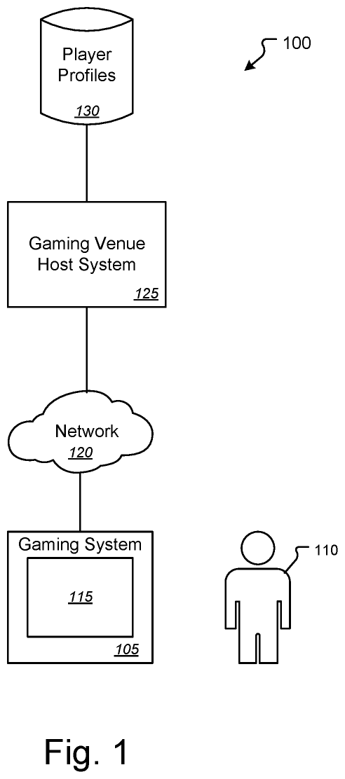

FIG. 1 is a block diagram illustrating an exemplary environment in which embodiments of the present disclosure may be implemented. As illustrated in this example, the environment 100 can comprise a gaming system 105. The gaming system can comprise, but is not limited to, an Electronic Gaming Machine (EGM), Video Lottery Terminal (VLT), kiosk, web browser, mobile phone, virtual reality device, or any other device capable of executing an electronic game. Such a game can include, but is not limited to, slots, video slots, video poker, keno, blackjack, etc. to be played by a player 110, e.g., in a casino or other gaming venue.

According to one embodiment, the gaming system 105 can comprise a multigame system providing a plurality of different games, e.g., different games, game types, versions of the same or different games, etc. Accordingly, the gaming system 105 can present a game selection user interface 115 or “chooser” through which the available games can be presented and selected by the player 110.

The gaming system 105 can be communicatively coupled with a network 120. The network 120 can include any one or more wired and/or wireless, local-area and/or wide-area networks as known in the art including, but not limited to, the Internet. A gaming venue host system 125 can also be coupled with the network 120. The gaming venue host system 125 can comprise any one or more servers and/or other computing devices as known in the art. Generally speaking, the gaming venue host system 125 can perform any number of backend functions for a casino or other gaming venue in which the gaming system 105 is installed. For example, the gaming venue host system 125 can maintain a set of player profiles 130 storing preferences and/or other information for players of the gaming system 105. In some implementations, the player profiles 130 may be stored, accessed, and/or maintained by the gaming system 105, perhaps within the gaming system 105 itself instead of or in addition to the gaming venue host system 125.

Embodiments of the present disclosure are directed to presenting a filtered list of electronic games available on a multigame gaming system 105. Generally speaking, rather than presenting a list of games, e.g., by game name, through the game selection interface 115, the gaming system 105 can provide a list of game features. For example, the features can include, but are not limited to, any of a free game bonus feature, a wild feature, a multiplier feature, a pick-a-prize bonus feature, a progressive prize feature, and/or others.

The player 110 can then select one or more desired game features. Based on these selections, the gaming system 105 can present a filtered list of games which include those, selected feature(s). The feature(s) a player selected can be saved to the player profile 130 so that if multiple games have similar features, advertisements or suggestions could be shown directly in the electronic game, e.g., as a banner while a game is being played to promote other games. This can comprise a message such as “If you like this game, try Game X.” When such an in-game suggestion is presented recommending another game, an option can also be presented to allow the player to switch to that other game directly, e.g., by pressing or clicking a button and without having to go to the game selection interface 115.

Additionally, or alternatively, such suggestions can be presented on the occurrence of some event. For example, when the player 110 cashes out, the selected features could be used to list games with similar features directly on the cashout ticket. In another example, a pop-up could appear on the display of the gaming system 105 indicating other games with similar features either when the player cashes out or inserts additional money.

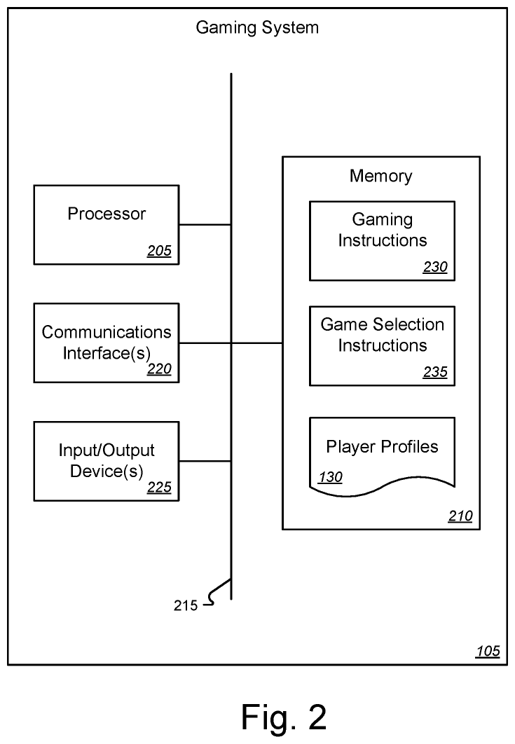

FIG. 2 is a block diagram illustrating additional details of components of an exemplary gaming system according to one embodiment of the present disclosure. As illustrated in this example, a gaming system 105 such as described above can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the gaming system 105 as described herein.

The memory 210 can be coupled with and readable by the processor 205 via a communications bus 215. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with one or more communication interface(s) 220 and one or more input/output devices 225 via the communications bus 215. The communication interface(s) 220 can comprise, for example, a Bluetooth, WiFi, cellular, and/or other type of wireless communications interface. Via the communication interface(s) 220, the gaming system 105 can communication with other devices and/or systems through a communications network 120 as described above. The input/output devices 225 can include, but are not limited to a display device such as a Liquid Crystal Display (LCD), Light Emitting Diode (LED), Organic Light Emitting Diode (OLED), or other type of display, a ticket printer, etc.

The memory 210 can store therein a set of gaming instructions 230 which, when executed by the processor 205, cause the processor 205 to execute an electronic game. The electronic game can be any of a wide variety of electronic games of chance including, but not limited to, slots, video slots, video poker, keno, blackjack, etc. to be played by a player, e.g., in a casino or other gaming venue. As noted above, the gaming system 105 can comprise a multigame system providing any number of different electronic games.

The memory 210 can also store therein a set of game selection instructions 235. Generally speaking, and as introduced above, the game selection instructions 235, when executed by the processor 205, can cause the processor 205 to present, through the display or other input/output device 225, a game selection user interface, i.e., a chooser interface, providing for selection of an electronic game of a plurality of electronic games available on the gaming system 105. This interface can include a list of game features for one or more games available in the gaming system 105. For example, the features can comprise any of a free game bonus feature, a wild feature, a multiplier feature, a pick-a-prize bonus feature, a progressive prize feature, and/or others. The game selection instructions 235 can cause the processor 205 to receive a selection of a feature of a plurality of features of the plurality of electronic games available on the gaming system can be received through the game selection user interface.

The game selection instructions 235 can cause the processor to filter a list of the plurality of electronic games available on the gaming system based on the selected feature(s) of the plurality of features, i.e., filtered to include only those games having the selected feature(s) and present the filtered list of the plurality of electronic games available on the gaming system through the game selection user interface. The game selection instructions 235 can further cause the processor 205 to receive a selection of an electronic game from the filtered list of the plurality of electronic games available on the gaming system through the game selection user interface and initiate execution of the selected electronic game.

According to one embodiment, the game selection instructions 235 can further cause the processor 205 to save the received selection of the feature of the plurality of features in a profile associated with a player of the selected electronic game. During execution of the selected electronic game, the game selection instructions 235 can cause the processor 205 to provide, through the display or other input/output device 225, an indication of a suggested electronic game based on the profile associated with the player of the selected electronic game, receive a request to switch to the suggested electronic game and in response, stop execution of the selected electronic game and initiate execution of the suggested electronic game.

Additionally, or alternatively, the game selection instructions 235 can cause the processor 205 to, upon detection of an event in the selected electronic game, provide a list of a plurality of electronic games through the display or other input/output device 225 based on the selected feature of the plurality of features. For example, the event in the selected electronic game can comprise a cash out from the selected electronic game. In such cases, providing the list of the plurality of electronic games can comprise printing the list of the plurality of electronic games on a cash out ticket. Additionally, or alternatively, providing the list of the plurality of electronic games can comprise providing a pop-up window in a display of the gaming system.

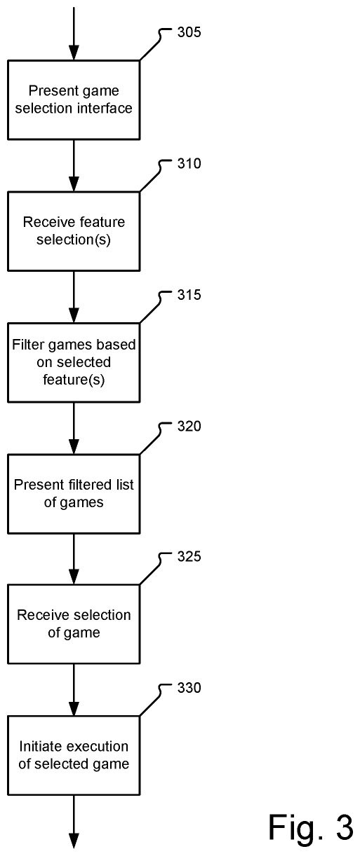

FIG. 3 is a flowchart illustrating an exemplary process for presenting available games in a multigame system according to one embodiment of the present disclosure. As illustrated in this example, selecting electronic games available in a multigame system can comprise presenting 305 a game selection user interface providing for selection of an electronic game of a plurality of electronic games available on the gaming system. This interface can include a list of game features for one or more games available in the gaming system. For example, the features can comprise any of a free game bonus feature, a wild feature, a multiplier feature, a pick-a-prize bonus feature, a progressive prize feature, and/or others. A selection of a feature of a plurality of features of the plurality of electronic games available on the gaming system can be received 310 through the game selection user interface.

A list of the plurality of electronic games available on the gaming system can be filtered 315 based on the selected feature(s) of the plurality of features, i.e., filtered to include only those games having the selected feature(s). The filtered list of the plurality of electronic games available on the gaming system can be presented 320 through the game selection user interface. A selection of an electronic game from the filtered list of the plurality of electronic games available on the gaming system can be received 325 through the game selection user interface. Execution of the selected electronic game can be initiated 330.

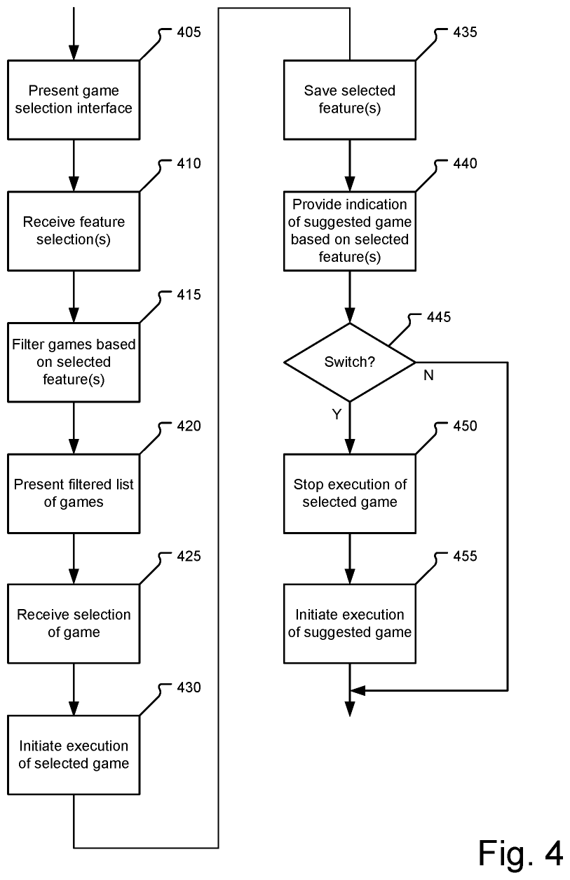

FIG. 4 is a flowchart illustrating an exemplary process for presenting available games in a multigame system according to another embodiment of the present disclosure. As illustrated in this example, selecting electronic games available in a multigame system can comprise presenting 405 a game selection user interface providing for selection of an electronic game of a plurality of electronic games available on the gaming system based on a list of game features for one or more games available in the gaming system. A selection of a feature of a plurality of features of the plurality of electronic games available on the gaming system can be received 410 through the game selection user interface.

A list of the plurality of electronic games available on the gaming system can be filtered 415 based on the selected feature(s) of the plurality of features. The filtered list of the plurality of electronic games available on the gaming system can be presented 420 through the game selection user interface. A selection of an electronic game from the filtered list of the plurality of electronic games available on the gaming system can be received 425 through the game selection user interface. Execution of the selected electronic game can be initiated 430.

As illustrated in this example, the received 425 selection of the feature of the plurality of features can be saved 435 in a profile associated with a player of the selected electronic game. During execution of the selected electronic game, an indication of a suggested electronic game can be provided 440 based on the profile associated with the player of the selected electronic game. A determination 445 can be made as to whether a request to switch to the suggested electronic game has been received during execution of the selected electronic game. In response to determining 445 a request to switch to the suggested electronic game has been received, execution of the selected electronic game can be stopped 450 and execution of the suggested electronic game can be initiated 455.

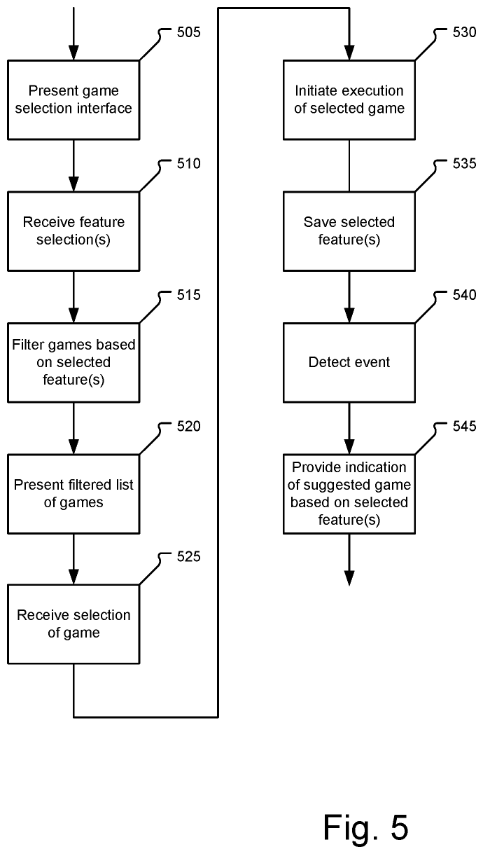

FIG. 5 is a flowchart illustrating an exemplary process for presenting available games in a multigame system according to yet another embodiment of the present disclosure. As illustrated in this example, selecting electronic games available in a multigame system can comprise presenting 505 a game selection user interface providing for selection of an electronic game of a plurality of electronic games available on the gaming system based on a list of game features for one or more games available in the gaming system. A selection of a feature of a plurality of features of the plurality of electronic games available on the gaming system can be received 510 through the game selection user interface.

A list of the plurality of electronic games available on the gaming system can be filtered 515 based on the selected feature(s) of the plurality of features. The filtered list of the plurality of electronic games available on the gaming system can be presented 520 through the game selection user interface. A selection of an electronic game from the filtered list of the plurality of electronic games available on the gaming system can be received 525 through the game selection user interface. Execution of the selected electronic game can be initiated 530. In some cases, an indication of the selected feature(s) can be saved 535, e.g., in a profile for the player.

As illustrated in this example, upon detection 540 of an event in the selected electronic game, a list of a plurality of electronic games can be provided 545 based on the selected feature(s) of the plurality of features. For example, the event in the selected electronic game can comprise a cash out from the selected electronic game. In such cases, providing 545 the list of the plurality of electronic games can comprise printing the list of the plurality of electronic games on a cash out ticket. Additionally, or alternatively, providing 545 the list of the plurality of electronic games can comprise providing a pop-up window in a display of the gaming system.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method for selecting electronic games available in a multigame system, the method comprising:
presenting, by a processor of a gaming system, a game selection user interface providing for selection of an electronic game of a plurality of electronic games available on the gaming system;
receiving, by the processor of the gaming system, through the game selection user interface, selection of a feature of a plurality of features of the plurality of electronic games available on the gaming system;
filtering, by the processor of the gaming system, a list of the plurality of electronic games available on the gaming system based on the selected feature of the plurality of features;
presenting, by the processor of the gaming system, through the game selection user interface, the filtered list of the plurality of electronic games available on the gaming system;
receiving, by the processor of the gaming system, through the game selection user interface, a selection of an electronic game from the filtered list of the plurality of electronic games available on the gaming system; and
initiating, by the processor of the gaming system, execution of the selected electronic game.

2. The method of claim 1, further comprising saving, by the processor of the gaming system, the received selection of the feature of the plurality of features in a profile associated with a player of the selected electronic game.

3. The method of claim 2, further comprising providing, by the processor of the gaming system, during execution of the selected electronic game, an indication of a suggested electronic game based on the profile associated with the player of the selected electronic game.

4. The method of claim 3, further comprising:
receiving, by the processor of the gaming system, during execution of the selected electronic game, a request to switch to the suggested electronic game;
stopping, by the processor of the gaming system, execution of the selected electronic game; and
initiating, by the processor of the gaming system, execution of the suggested electronic game.

5. The method of claim 1, further comprising, upon detection of an event in the selected electronic game, providing, by the processor of the gaming system, a list of a plurality of electronic games based on the selected feature of the plurality of features.

6. The method of claim 5, wherein the event in the selected electronic game comprises a cash out from the selected electronic game.

7. The method of claim 6, wherein providing the list of the plurality of electronic games comprises printing the list of the plurality of electronic games on a cash out ticket.

8. The method of claim 5, wherein providing the list of the plurality of electronic games comprises providing a pop-up window in a display of the gaming system.

9. A gaming system comprising:
a display device;
a processor coupled with the display device; and
a memory coupled with and readable by the processor and storing therein a set of instructions which, when executed by the processor, causes the processor to:
present, through the display device, a game selection user interface providing for selection of an electronic game of a plurality of electronic games available on the gaming system;
receive, through the game selection user interface, selection of a feature of a plurality of features of the plurality of electronic games available on the gaming system;
filter a list of the plurality of electronic games available on the gaming system based on the selected feature of the plurality of features;
present, through the game selection user interface, the filtered list of the plurality of electronic games available on the gaming system;
receive, through the game selection user interface, a selection of an electronic game from the filtered list of the plurality of electronic games available on the gaming system; and
initiate execution of the selected electronic game.

10. The gaming system of claim 9, wherein the selected feature comprises a free game bonus feature.

11. The gaming system of claim 9, wherein the selected feature comprises a wild feature.

12. The gaming system of claim 9, wherein the selected feature comprises a multiplier feature.

13. The gaming system of claim 9, wherein the selected feature comprises pick-a-prize bonus feature.

14. The gaming system of claim 9, wherein the selected feature comprises a progressive prize feature.

15. An Electronic Gaming Machine (EGM) comprising:
a display device;
a processor coupled with the display device; and
a memory coupled with and readable by the processor and storing therein a set of instructions which, when executed by the processor, causes the processor to:
present, through the display device, a game selection user interface providing for selection of an electronic game of a plurality of electronic games available on the gaming system;
receive, through the game selection user interface, selection of a feature of a plurality of features of the plurality of electronic games available on the gaming system;
filter a list of the plurality of electronic games available on the gaming system based on the selected feature of the plurality of features;
present, through the game selection user interface, the filtered list of the plurality of electronic games available on the gaming system;
receive, through the game selection user interface, a selection of an electronic game from the filtered list of the plurality of electronic games available on the gaming system; and
initiate execution of the selected electronic game.

16. The EGM of claim 15, wherein the instructions further cause the processor to save the received selection of the feature of the plurality of features in a profile associated with a player of the selected electronic game.

17. The EGM of claim 16, wherein the instructions further cause the processor to provide, during execution of the selected electronic game, an indication of a suggested electronic game based on the profile associated with the player of the selected electronic game.

18. The EGM of claim 17, wherein the instructions further cause the processor to:
receive, during execution of the selected electronic game, a request to switch to the suggested electronic game;
stop execution of the selected electronic game; and
initiate execution of the suggested electronic game.

19. The EGM of claim 15, wherein the instructions further cause the processor to, upon detection of an event in the selected electronic game, provide a list of a plurality of electronic games based on the selected feature of the plurality of features.

20. The EGM of claim 19, wherein the event in the selected electronic game comprises a cash out from the selected electronic game.
